(19) United States
(12) Patent Application Publication
(10) Pub. No.: US 2015/0312601 A1
(43) Pub. Date: Oct. 29, 2015

(54) METHODS AND APPARATUSES INCLUDING A STATISTICAL MULTIPLEXER WITH MULTIPLE CHANNEL RATE CONTROL

(71) Applicant: MAGNUM SEMICONDUCTOR, INC., MILPITAS, CA (US)

(72) Inventor: PAVEL NOVOTNY, WATERLOO (CA)

(73) Assignee: MAGNUM SEMICONDUCTOR, INC., MILPITAS, CA (US)

(21) Appl. No.: 14/263,535

(22) Filed: Apr. 28, 2014

(51) Int. Cl. H04N 21/2365; H04N 21/234; H04N 21/2383; H04N 21/647; H04N 21/236

(52) U.S. Cl. CPC H04N 21/23655; H04N 21/64792; H04N 21/64769; H04N 21/23611; H04N 21/2383; H04N 21/23406

(57) ABSTRACT

Examples methods and apparatuses including a statistical multiplexer (statmux) system with multiple channel rate control are described herein. The statmux system includes a rate controller, multiplex control unit and a plurality of encoders. An encoder of the plurality of encoders may be configured to provide a respective encoded bitstream of encoded coding units. The rate controller may buffer respective coding units of at least two of the plurality of channels based on statistical information from the plurality of encoders. The multiplex control unit may adjust multiplexing instructions for multiplexing the plurality of channels based on statistical information from the plurality of encoders, and may provide feedback to the rate controller based on the adjusted multiplexing instructions. The rate controller may provide a quality parameter to the plurality of encoders having a value based on the amount of buffered coding units and the feedback from the multiplex control unit.

### TECHNICAL FIELD

Embodiments described herein relate to video encoding; examples of a statistical multiplexer with multiple channel rate control to combine multiple channels are described.

### BACKGROUND

In content distribution environments, communication links may be created with each communication link having a fixed bandwidth. The fixed bandwidth of a communication link is typically higher than the bandwidth needs of any single channel of media content provided from a content provider. Thus, content providers may pool encoded bitstreams of several channels together to maximize use of the bandwidth of the communication link. Modern block based video coding standards such as H.261, H.262, H.263 and H.264 take advantage of temporal and spatial redundancy of a channel to achieve efficient video compression, but produce variable bitrate (VBR) bitstreams. As complexity of content of the channel changes, the bitrates of the encoded bitstreams may vary over time. A quantification of complexity is often specific to a video coding methodology and an encoder used to encode the content. One issue with pooling encoded bitstreams of several channels is managing the variability of the bitrates of each encoded bitstream to efficiently use bandwidth of a constant bitrate communication link while maintaining consistent video quality on each channel.

A conventional implementation of managing bandwidth of a pool of encoded bitstreams may use a statistical multiplexer (statmux) system. The statmux system may include several encoders, a controller, and a multiplexer. The inputs to the encoders may be content channels to be encoded for the purpose of content distribution. Encoded bitstreams are provided from the several encoders to a multiplexer. The multiplexer may combine the encoded bitstreams into a multi-program transport stream (MPTS). On the receiving side, one or more encoded bitstreams are de-multiplexed from the MPTS using standard de-multiplexing techniques and decoded. A statmux system may be beneficial in this scenario since it can pool multiple channels together in such a way that the final bitstream has a continuous bitrate (CBR), which may be distributed over existing distribution networks.

A typical way of controlling bitrates of the individual encoders in a statmux system is to divide time into time slots having fixed periods, and to divide the available bandwidth of the communication link for a time slot between the channels by assigning a bitrate to each channel. Each encoder is likely to be producing different bitrates at different times, and on average, if the complexity of the content on one channel increases, the complexity of another channel's content might be reduced in the same time. The encoders then use local rate controllers to encode content based on the assigned bitrates for a time slot and information about the content received by the individual controller implementing rate control without exceeding the given limits to avoid exceeding a bandwidth of the communication link for the time slot.

### BRIEF DESCRIPTION OF THE DRAWINGS

FIG. 1 is a block diagram of a content distribution system including a statmux system with multiple channel rate control according to an embodiment of the disclosure;

FIG. 2 is a block diagram of a content distribution system including a statmux system with multiple channel rate control according to an embodiment of the disclosure;

FIG. 3 is a block diagram of a content distribution system including a statmux system with multiple channel rate control according to an embodiment of the disclosure;

FIG. 4A is a block diagram of a multiplexer control unit according to an embodiment of the disclosure;

FIG. 4B is a block diagram of an encoder according to an embodiment of the disclosure;

FIGS. 5A and 5B are timing diagrams of a model output buffer and channel transmission bitrates associated with multiple channels according to an embodiment of the disclosure;

FIG. 6 is a schematic illustration of a media delivery system according to an embodiment of the disclosure;

FIG. 7 is a schematic illustration of a video distribution system that may make use of a media delivery system described herein; and

FIG. 8 is a flowchart for a method for controlling the multiplexer output using rates associated with individual channels according to an embodiment of the disclosure.

### DETAILED DESCRIPTION

Certain details are set forth below to provide a sufficient understanding of embodiments of the disclosure. However, it will be clear to one having skill in the art that embodiments of the disclosure may be practiced without these particular details, or with additional or different details. Moreover, the particular embodiments described herein are provided by way of example and should not be used to limit the scope of the disclosure to these particular embodiments. In other instances, well-known video components, encoder or decoder components, circuits, control signals, timing protocols, and software operations have not been shown in detail in order to avoid unnecessarily obscuring the disclosure.

There may be potential complexities associated with the conventional statmux setup described above. One potential complexity is that the controller determines an assigned bitrate for each encoder for a respective current frame to be encoded, without considering the complexity of future frames to be encoded. If complexity varies significantly over the course of a series of frames, the quality of the encoded video content may be constantly changing at a rapid rate. Further, as explained above, the encoders may produce a variable bitrate bitstream based on complexity of the video data. Thus, for an assigned bitrate, a less complex frame may have noticeably better quality than a more complex frame. Using assigned bitrates to control rates of encoders may therefore result in noticeable changes in video quality.

Another potential complexity may result from a delay between when an encoder encodes some portion of the content based on the assigned bitrate and when the encoded bitstream containing the encoded portion actually appears on the output of the encoder. The delay may be variable, depending on the complexity of the content and the assigned encoding bitrate. For example, the variable delay may be based on a method used to control the rate of the encoders. Many standard rate control methodologies in encoders use a Virtual Buffer Verifier (VBV) buffer model. In the VBV buffer model, each encoder provides encoded frames to its own VBV buffer. The encoders may provide encoded frames of various sizes. Frames will be removed from the VBV buffer for transmission at a constant bitrate. Since data is output from the VBV buffer at a constant bit-rate, and sizes of frames put into the VBV buffer may vary in accordance with the encoding methodology and quality used to encode, an amount of data in the VBV buffer may rise and fall accordingly. The variable delay may be a function of the amount of data present in the VBV buffer (e.g., more data in the VBV buffer increases the delay from when the time data is provided to the buffer to the time it is removed at a constant bitrate). Thus, in addition to assigning a bitrate, the controller estimates when the encoded bitstream will be provided at an output without knowing the level of the respective VBV buffer. In some embodiments, the VBV buffer may be a physical buffer in which data may be stored, and in other embodiments the VBV buffer may not be a physical buffer but may represent a model, such as a software model, of the amount of data available relative to the constant bitrate output.

Additionally, since each encoder in conventional schemes is assigned a fixed bit budget for a fixed time period (e.g., the assigned bitrate), an encoder may have to adjust a video quality to fit the media content to be encoded into the fixed bit budget. The adjustments made to meet the timing and encoding bitrate conditions may degrade the video and result in noticeably reduced video quality.

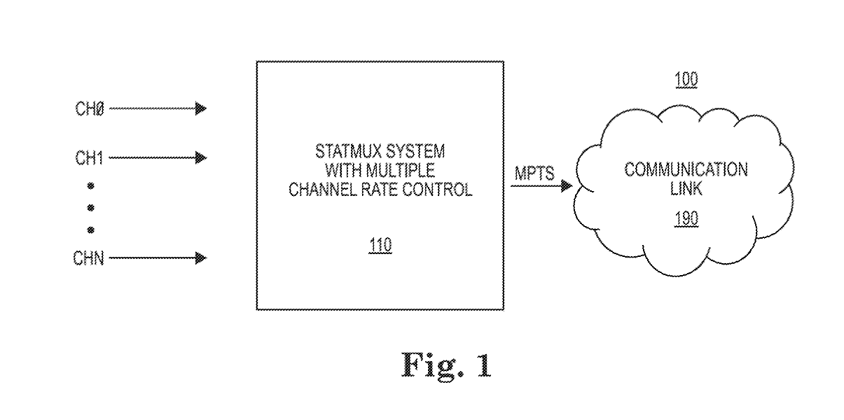

FIG. 1 is a block diagram of a content distribution system 100 including a statistical multiplexer (statmux) with multiple channel rate control 110 according to an embodiment of the disclosure. The content distribution system 100 may be implemented in hardware, software, firmware, or combinations thereof, and may include control logic, logic gates, processors, memory, and/or any combination or sub-combination of the same, and may be configured to encode and/or compress one or more CH0-N channels to provide one or more encoded bitstreams using one or more encoding techniques, and to combine the one or more encoded bitstreams into a multi-program transport stream (MPTS) to provide over a communication link 190.

The statmux with multiple channel rate control 110 may include one or more encoders, a rate controller (RC) for controlling the encoders, and a multiplexer control unit (MCU) for controlling multiplexing rates. As explained above, the statmux with the multiple channel rate control 110 may receive coding units via the respective CH0-N channels, and generate encoded bitstreams based on the coding units using one or more encoding techniques. Examples of coding units include, but are not limited to, frames, sub-frames, regions, and macroblocks. In the interest of clarity, operation of the statmux with the multiple channel rate control 110 will discussed in terms of frames as coding units, although in other examples other coding units may be used. The encoded bitstreams may be variable bitrate bitstreams, with variance based on, for example, a complexity of the encoded frames of content of the respective CH0-N channels. Statistics related to the encoded bitstreams are transmitted to both the RC and the MCU. In part, the MCU modifies parameters supplied by the RC in order to control the multiplexer and reduce the bitrate variations of the individual encoded bitstreams. These parameters may include, but are not limited to, timing of the frames. Other inputs to the MCU include statistics related to the encoded bitstreams, such as frame sizes. The output of the MCU is transmitted to the multiplexer and includes control parameters for controlling the multiplexing rates per interval of the bitrates for individual channels CH0-N that are being multiplexed by the multiplexer.

Controlling the multiplexing rates per interval of the bitrates for individual channel generally refers to the multiplexer removing an amount of bits from an individual channel buffer in order to combine the bitstreams into an MPTS output that has a constant bitrate (CBR). If there is not enough data in the pooled buffer for multiplexing, then the multiplexer may stuff the remaining space with null packets, or utilize other bitstuffing techniques, in order to maintain the CBR. Each individual channel may have a specified maximum bitrate limit that the multiplexer may not exceed when removing bits to be multiplexed. If an individual channel is exceeds the maximum bitrate limit, then the multiplexer may ensure the limit is not exceeded by clipping the bitstream at multiplexing. The statmux with the multiple channel rate control 110 may combine the encoded bitstreams into the MPTS based on the outputted mux control signal from the MCU and provide the MPTS to the communication link 190. Recall the communication link 190 may have a fixed bandwidth.

In operation, the statmux with multiple channel rate control 110 may manage encoding and combining of the CH0-N channels into the MPTS to be transmitted over the communication link 190. Generally, the statmux with multiple channel rate control 110 may utilize rate control to determine a quality level at which to encode each of the associated channels. Rate control generally refers to the use of information about more than one channel in determining a quality at which to encode a channel. The statmux with multiple channel rate control 110 may also control the multiplexing rates per time interval of individual channels CH0-N. For example, the statmux with multiple channel rate control 110 may use a smart bandwidth sharing algorithm. This algorithm may allocate a bit rate per channel pool rate proportional to the amount of pooled data stored in the buffer. For example, if a first channel has buffered twice the amount of data in its buffer compared to a second channel, then the first channel will use ⅔ of the pool rate, while the second channel will use ⅓ of the pool rate. The statmux with multiple channel rate control 110 may also prioritize designated individual premium channels. A premium channel may be allocated all the bandwidth required (up to the individual channel's bitrate limit) to transmit the channel's data, thereby minimizing any reduction of bitstream quality caused by feedback operations by the RC and MCU. The statmux with multiple channel rate control 110 may also designate individual channels to have a CBR, which generally refers to a situation where an individual channel would not have a variable bitrate, but would always maintain a constant bitrate when multiplexed into the final MPTS.

While encoding the encoded coding units, a rate controller may provide a quality parameter (QP) to each of the encoders having a value based on statistical information related to encoded coding units. The value of the QP provided to each of the encoders may be based on statistical information from more than one channel, including other channels not directly associated with an individual encoder. The encoders may encode coding units of an associated CH0-N channel using the provided QP and provide the encoded coding units in a respective encoded bitstream. The encoding methodologies for each encoder may result encoded frames of the respective CH0-N channel having variable bitrates. The statmux with multiple channel rate control 110 may combine the encoded bitstreams provided from each of the encoders into the MPTS and provide the MPTS at an output over the communication link 190.

The multiplexer of the statmux with multiple rate control 110 may packetize each encoded coding unit of the selected group of coded coding units into two or more packets. Based on control signals sent by the MCU, the multiplexer may transmit the packets of each encoded coding units of the selected group of encoded coding units. As explained above, in order to maintain the CBR of the MPTS, the multiplexer may perform packet stuffing to compensate for any unused bandwidth in the final MPTS.

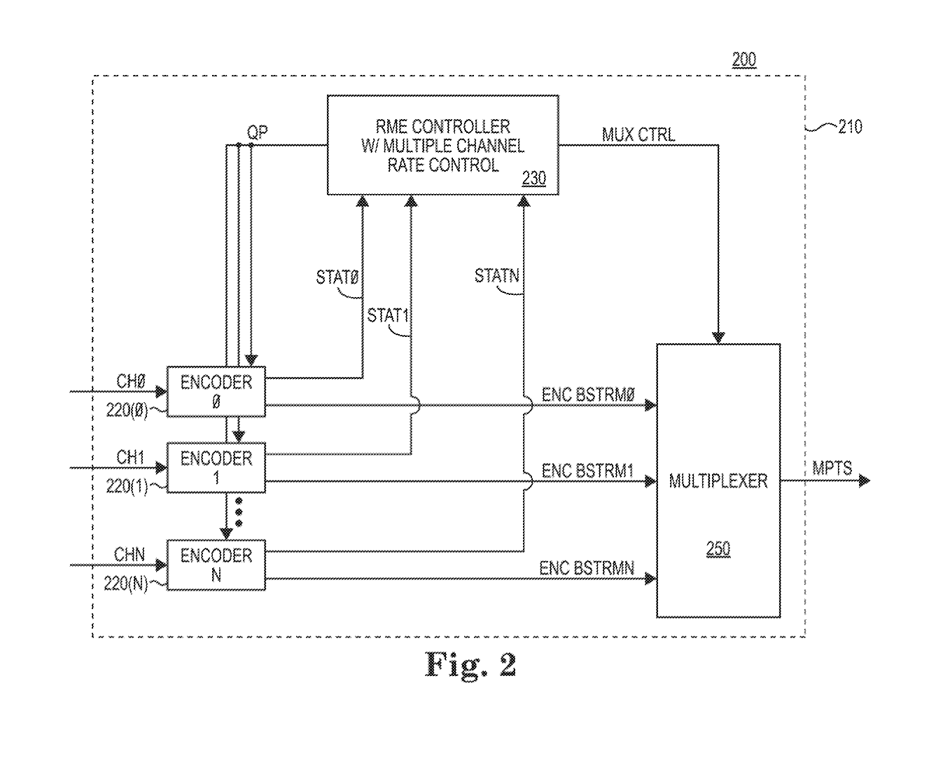

FIG. 2 is a block diagram of a statistical multiplexer (statmux) system 200 with multiple channel rate control according to an embodiment of the disclosure. The statmux with multiple channel rate control 210 may be implemented in hardware, software, firmware, or combinations thereof, and may include control logic, logic gates, processors, memory, and/or any combination or sub-combination of the same, and may encode and/or compress respective frames of the CH0-N channels to provide one or more encoded bitstreams 0-N using one or more encoding techniques, and to combine the encoded bitstreams 0-N into a multi-program transport stream (MPTS) signal. The statmux with multiple channel rate control 210 may be used to implement the statmux with multiple channel rate control 110 of FIG. 1.

The statmux with multiple channel rate control 210 may include a rate controller (RC) with multiplex control unit (MCU) 230. The RC with MCU 230 may receive statistical information STAT 0-N associated with encoded coding units of the respective CH0-N channels from one or more of the encoders 0-N 220(0-N). As explained above, examples of coding units may include, but are not limited to, frames, sub-frames, regions, and macroblocks. In the interest of clarity, operation of the statmux with multiple channel rate control 210 will discussed in terms of frames as coding units, although other coding units may be used in other examples. The STAT 0-N information may include information regarding encoded frames, such as but not limited to, information indicating an actual size of an encoded frame, unquantized frame size, complexity information based on a quality parameter, or combinations thereof. In some embodiments, the RC with MCU 230 may be implemented using rate control methods and rate controllers as described in U.S. patent application Ser. No. 13/886,047 filed on May 2, 2013, which is incorporated herein by reference in its entirety for any purpose.

The RC with MCU 230 may analyze the STAT 0-N information from the encoders 0-N 220(0-N) to select a quality parameter (QP) value. In some embodiments, the RC with MCU 230 may model a level of a model output buffer (e.g. amount of data stored in the model output buffer) based on the combined encoded bitstreams 0-N associated with the CH0-N channels. The model output buffer may have a target constant bitrate output. The target constant bitrate output may be based on a constant bitrate of the communication link. The RC with MCU 230 may provide the selected QP value to the encoders 0-N 220(0-N) having a value based on the statistical information, the level of the model output buffer, and feedback from the MCU. The feedback from the MCU may be based on the amount of packet stuffing any individual channel required during multiplexing in order to maintain the CBR of the final MPTS. This feedback allows the RC to adjust the number of bits produced by the encoders to align with the number of bits consumed by the multiplexer.

The encoders 0-N 220(0-N) may receive respective coding units via the respective CH0-N channels and provide respective frames via the encoded bitstreams 0-N at an output of each of the respective encoders. The encoders may be implemented in hardware, software, or combinations thereof. The encoders 0-N 220(0-N) may include respective entropy encoders, such as a variable-length coding encoder (e.g., Huffman encoder, context-adaptive variable length coding (CAVLC) encoder, or context-adaptive binary arithmetic coding (CABAC) encoder), and/or may encode the frames, for instance, at a macroblock level. Each macroblock may be encoded in intra-coded mode, inter-coded mode, bidirectionally, or in any combination or subcombination of the same. As an example, the encoders 0-N 220(0-N) may receive and encode frames via the respective CH0-N channels. The respective CH0-N channels may be encoded in accordance with one or more encoding algorithms or standards, such as MPEG-2, MPEG-4, H.263, H.264, and/or HEVC. The encoding methodologies and/or standards implemented by each encoder 0-N 220(0-N) may result in encoded frames having variable bitrates. The encoders 0-N 220(0-N) may further provide the respective STAT 0-N information to the RC with MCU 230. The respective STAT 0-N information may be based on a respective encoded frame.

The statmux with multiple channel rate control 210 may further include the multiplexer 250 configured to receive the encoded bitstreams 0-N from the respective encoders 0-N 220(0-N). The multiplexer 250 may packetize and transmit the encoded bitstreams 0-N into the MPTS based on the channel information in a multiplexer control signal, e.g. ALT MUX CTRL signal in FIG. 2, received from the RC with MCU 230, and to provide the MPTS to the communication link.

In an example operation, the RC with MCU 230 may manage transmission of encoded bitstreams 0-N having variable bitrates via the MPTS over a communication link. The communication link may have a fixed bandwidth (e.g., and a constant bitrate). The RC with MCU 230 may select a QP value to provide to the encoders based on the STAT 0-N information received from one or more of the encoders 0-N 220(0-N) and based on the level of the model output buffer, which has an associated target bitrate. The QP value may also be based on feedback from the MCU, which reports when channels are stuffed during multiplexing in order to maintain the CBR of the MPTS.

In encoding the encoded frames, each of the respective encoders 0-N 220 (0-N) may receive respective frames via the corresponding CH0-N channel. Responsive to receipt of respective frames, the encoders 0-N 220 (0-N) may encode the received respective frames based on the QP value selected by the RC with MCU 230. In some examples, the RC with MCU 230 may select a single QP value for use by all or multiple encoders. In other examples, the RC with bitrate smoother 230 may provide different QP values to different ones of the encoders. The encoded frames may be provided in the respective encoded bitstreams 0-N to the multiplexer 250. Responsive to encoding each respective frame, the associated encoder 0-N 220 (0-N) may provide updated respective STAT 0-N information to the RC with bitrate smoother 230. Examples of STAT 0-N information associated with a respective frame may include an actual encoded frame size, complexity information, unquantized encoded frame size information, and combinations thereof.

Responsive to receiving the updated STAT 0-N information from the respective encoder 0-N 220 (0-N), the RC with MCU 230 may perform a QP selection process. During the QP selection process, the RC with MCU 230 may update a level of the model output buffer based on an actual size of an encoded frame received in the updated STAT 0-N information and/or the level of the model output butter. Further, the RC with MCU 230 may analyze the updated STAT 0-N information to select a QP value. The RC with MCU 230 may also update a level of the model output buffer based on feedback from the MCU. This feedback from the MCU to the RC may include information related to model output buffer output underflow and overflow measured for individual channels during the multiplexing process for the MPTS.

The multiplexer 250 may packetize encoded frames into a series of packets. The multiplexer 250 may time multiplex packets of a selected group of encoded frames of the encoded bitstreams 0-N into the MPTS based on the respective channel information received via the multiplexer control signal, e.g. ALT MUX CTRL. In an alternative embodiment, each channel CH0-N may be multiplexed individually by its corresponding encoder 0-N 220 (0-N) into a simple transport stream (SPTS). These SPTS bitstreams may then be combined by a remuxer into the final MPTS.

As explained above, while the description of operation the statmux multiple channel rate control 210 is based on encoding of frames, it will be appreciated that operation of the statmux system 200 may be based on encoding of coding units, such as macroblocks, and/or other sub-coding units, such as portions of a frame, and the encoded coding units or encoded sub-coding units may be provided to the multiplexer 250 via the respective encoded bitstreams 0-N. It will be appreciated that, while FIG. 2 depicts three encoders, a statmux with multiple channel rate control 210 may include 2, or more than three encoders. The encoders 0-N 220 (0-N) may have different architecture and/or may encode the encoded frames of the respective CH0-N channels using different encoding methodologies or standards, and may operate at different rates. In some embodiments, the RC with MCU 230 may operate at least as fast as a channel of the CH0-N channels having a fastest frame rate. It will be appreciated that encoding of channels may include other dependencies beyond bitrates and timing.

Further, it will also be appreciated that the RC with MCU 230 may provide a different QP to each of the encoders 0-N 220 (0-N). For example, the QPs may be assigned as follows: (1) QP deltas can be applied to individual channels of the CH0-N to introduce quality differences between the individual channels (e.g., premium channels with higher quality may be guaranteed a QP that achieves a quality a predetermined amount greater than one or more other channels); (2) fixing a QP for one or more of the CH0-N channels (e.g., a guaranteed quality of the one or more channels); (3) assigning minimum and maximum quality limits for one or more channels, which may be a more reliable way than specifying minimum and maximum bitrates, in some examples; (4) using non-linear quality control to limit changing a QP value for a particular channel or channels relative to changing QP for other channels; and/or (5) quality balancing between different encoders 0-N 220 (0-N) of the same and different compression formats and different encoders' configurations within the statmux system 200. It will also be appreciated the one or more encoded bitstreams 0-N may be excluded from being adjusted during multiplexing by MCU 334.

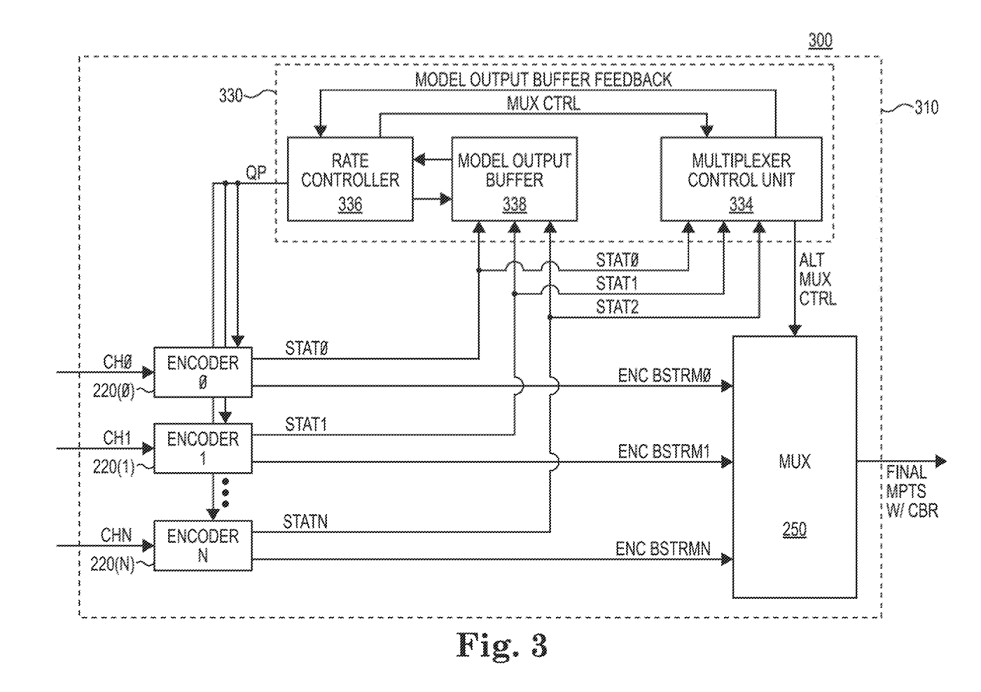

FIG. 3 is a block diagram of a statistical multiplexer (statmux) system 300 including a statmux with multiple channel rate control 310 according to an embodiment of the disclosure. The statmux with multiple channel rate control 310 may be implemented in hardware, software, firmware, or combinations thereof, and may include control logic, logic gates, processors, memory, and/or any combination or sub-combination of the same, and may encode and/or compress respective frames of the CH0-N channels to provide one or more encoded bitstreams 0-N using one or more encoding techniques, and to combine the encoded bitstreams 0-N into a multi-program transport stream (MPTS) signal. The statmux with multiple channel rate control 310 includes elements that have been previously described with respect to the statmux with multiple channel rate control 210 of FIG. 2. Those elements have been shown in FIG. 3 using the same reference numbers used in FIG. 2 and operation of the common elements is as previously described. Consequently, a detailed description of the operation of these elements will not be repeated in the interest of brevity. The statmux with multiple channel rate control 310 may be used in the statmux with multiple channel rate control 110 of FIG. 1 and/or the statmux with multiple channel rate control 210 of FIG. 2.

The statmux with multiple channel rate control 310 may include the RC with MCU 330. The RC with MCU 330 may include a rate controller 336 coupled a model output buffer 338 and to a MCU 334. The rate controller 336 may receive statistical information STAT 0-N associated with encoded coding units of the respective CH0-N channels from one or more of the encoders 0-N 220 (0-N). The STAT 0-N information may include information indicating an actual size of an encoded coding unit, quantization information based on a quality parameter, or combinations thereof. As explained with reference to FIG. 2, examples of coding units may include frames, sub-frames, regions, macroblocks, etc. In the interest of clarity, operation of the statmux with multiple channel rate control 310 will discussed in terms of frames as coding units, although other coding units may be used in other examples. Based on the STAT 0-N information, the rate controller 336 may update a level of the model output buffer 338 by adding actual encoded frame sizes to the model output buffer 338. The rate controller 336 may further provide a raw multiplexer control signal, e.g. RAW MUX CTRL, having channel information associated with an encoded bitstream based on the associated STAT 0-N information, an amount of data in (e.g., a level of) the model output buffer 338, and feedback from MCU 334.

The model output buffer 338 may be a physical buffer or may be a software model including a representation of an amount of data contained in (e.g., a level of) a modeled output buffer. The model output buffer 338 may model an output buffer having a target bitrate. In some embodiments, the target bitrate may be based on or may be equal to a constant bitrate of the communication link. A level of the model output buffer may be changed based on a size of an encoded frame received via the STAT 0-N information from the encoders 0-N 220 (0-N) (e.g., changing the level in a first direction based on the actual encoded frame size), while the level of the model output buffer 338 is continuously changing in a second direction at the target bitrate. In some embodiments, the first direction is increasing the level and the second direction is decreasing the level. In other embodiments, the first direction is decreasing the level and the second direction is increasing the level. The model output buffer 338 may provide a present level to the rate controller 336. Additionally, based on the present level of the model output buffer 338 and the STAT 0-N information from the encoders 0-N 220 (0-N) select a QP that results in the level of the model output buffer 338 staying within a target range (e.g. not filled over a maximum threshold and not depleted below a minimum threshold). The model output buffer 338 may also adjust its level based on feedback received from MCU 334. This feedback may be based the amount of stuffing per channel performed by multiplexer 250 in order to maintain the CBR of the final MPTS.

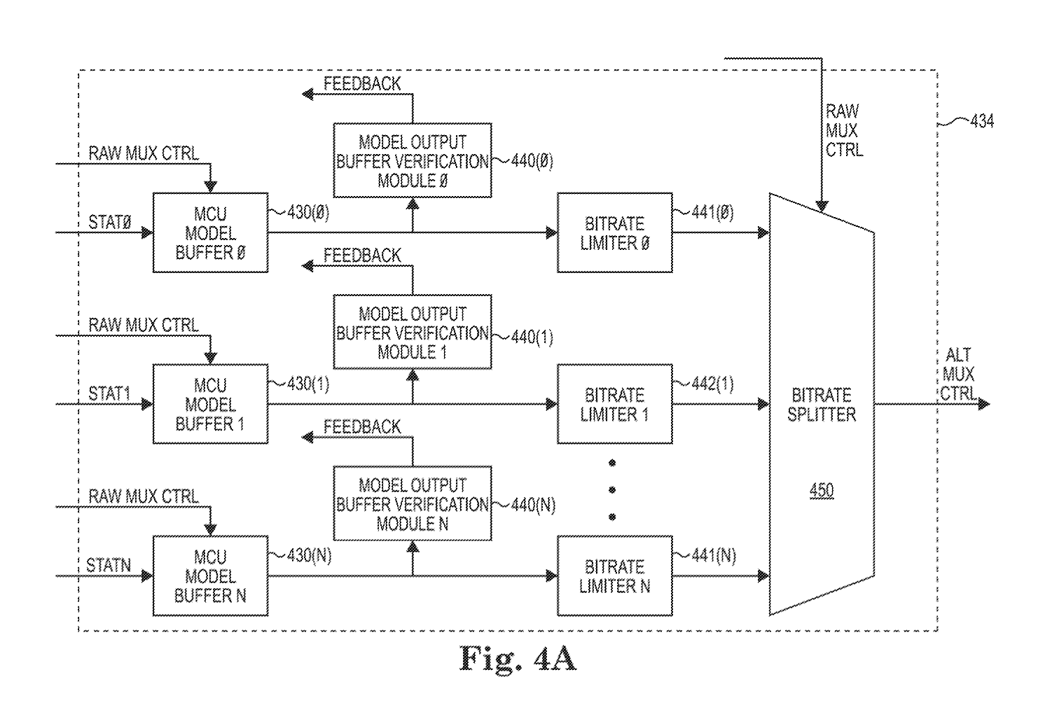

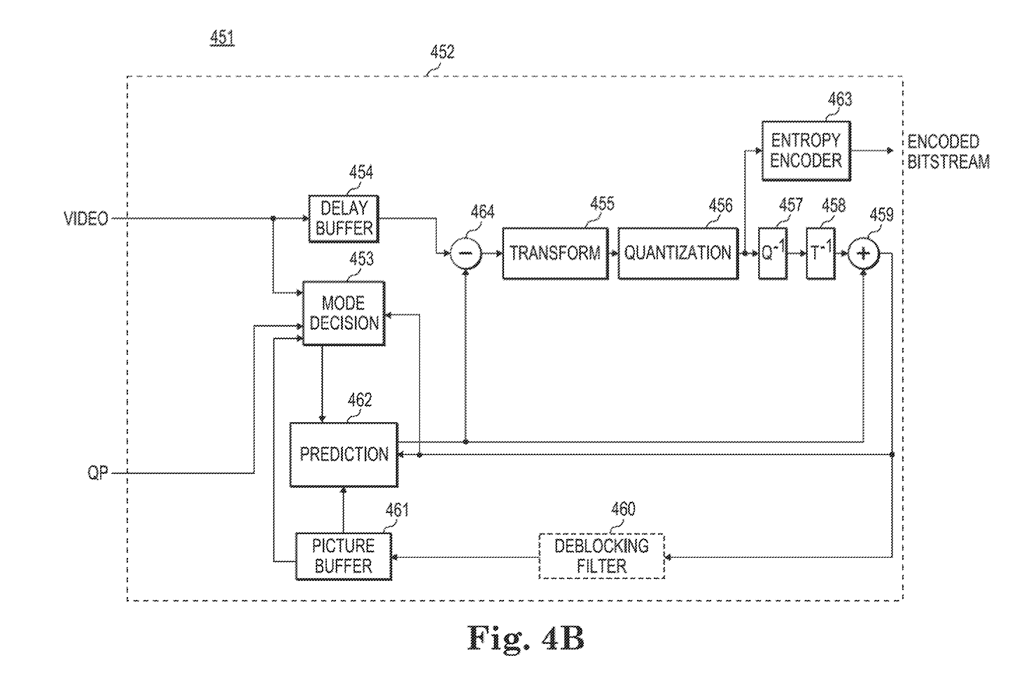

FIG. 4A is a block diagram of a multiplexer control unit (MCU) 434 according to an embodiment of the disclosure. The MCU 434 may be implemented in hardware, software, firmware, or combinations thereof, and may include control logic, logic gates, processors, memory, and/or any combination or sub-combination of the same. MCU 434 may be used to implement the statmux with multiple channel rate control 110 of FIG. 1, the statmux with multiple channel rate control 210 of FIG. 2, and/or the statmux with multiple channel rate control 310 of FIG. 3.

The MCU 434 is configured to receive the STAT 0-N information from encoders 0-N 220 (0-N) and the raw multiplexer control signal, e.g. RAW MUX CTRL, from the RC. From these inputs, MCU 434 provides feedback to the model output buffer and a multiplexer control signal, e.g. ALT MUX CTRL, to multiplexer 250. As described with respect to FIG. 2, the STAT 0-N information may include information indicating an actual size of an encoded coding unit, quantization information based on a quality parameter, or combinations thereof. The raw multiplexer control signal from the RC may provide the timing of the encoded bitstreams to each model MCU buffer 0-N. The raw multiplexer control signal may also provide the rate at which bitrate splitter 450 drains each model MCU buffer 430(0-N). Each channel CH0-N is verified for compliance with the model output buffer model via output buffer verification modules 0-N. This verification may check to see if the actual multiplexing rate corresponds to the expected rate that is set by the model output buffer. Based on this verification, MCU 434 provides feedback to the RC for the case of model output buffer overflow when packet stuffing is required for individual channels so that the CBR of the final MPTS can be maintained. In the case of model output buffer overflow, the model output buffer feedback may communicate to the RC to increase output from individual encoders. In the case of model output buffer underflow, MCU 434 may provide feedback to the RC so that the encoders 0-N 220 (0-N) can decrease output. The model output buffer may respond to this feedback from the MCU via the RC by adjusting buffer levels in order to maintain bitrate flow at a target level that minimizes overflow or underflow of data from the model output buffer, and thereby minimizing the amount of stuffing required for each channel. Model output buffer verification modules 440(0-N) may also verify that the model output buffer output is set to the correct level. Each individual channel CH0-N may also be designated with a maximum bitrate limit that may not be exceeded. Limiters 0-N 441(0-N) may delay bitstreams 0-N from MCU model buffers 430(0-N) if they exceed the bitrate limit. Bitrate splitter 450 assigns each encoded bitstream bandwidth based on the raw multiplexer control signal, e.g. RAW MUX CTRL, and STAT 0-N statistics in order to provide multiplexer 250 the multiplexer control signal, e.g. ALT MUX CTRL, for the actual multiplexing of the encoded bitstreams 0-N.

Bitrate splitter 450 may also allocate bandwidth to individual channels CH0-N using a smart bandwidth sharing algorithm. This algorithm may allocate a bit rate per channel pool rate proportional to the amount of pooled data stored in the buffer. For example, if a first channel has buffered twice the amount of data in its buffer compared to a second channel, then the first channel will use ⅔ of the pool rate, while the second channel will use ⅓ of the pool rate. While this example discusses bandwidth allocation between two channels, it is appreciated that bitrate splitter 450 would allocate bandwidth for all channels CH0-N in accordance with the amount of data buffered by each channel. Recall that the total bandwidth for allocation among all channels CH0-N to be multiplexed may be fixed.

As explained with reference to FIG. 2, each of the respective encoders 0-N 220(0-N) may encode the respective received frames using the QP value selected by the rate controller 336. The encoded frames may be provided in the respective encoded bitstream 0-N to the multiplexer 250. The multiplexer 250 may time multiplex the encoded bitstreams 0-N into the MPTS based on the channel information provided in the ALT MUX CTRL signal from the MCU 434.

Responsive to receiving the updated STAT 0-N information, the rate controller 336 may perform a QP selection operation. The QP selection operation may include the rate controller 336 providing an actual size of the encoded frame included in the updated STAT 0-N information to the model output buffer 338. The model output buffer 338 may update the buffer level based on the actual size of an encoded frame received from the rate controller 336. The QP selection process may include the rate controller 336 selecting a QP value based on the level of the model output buffer 338, the feedback from the MCU 434, and the STAT 0-N information received from the encoders (0-N) 220(0-N).

The MCU 434 may perform analysis on model output buffer 338 to verify and, if necessary, correct any possible bitrate violations for encoded bitstreams 0-N by providing feedback to the RC 336. RC 336 may then adjust the model output buffer 338 on the basis of this feedback from MCU 434, and adjust the encoding rate at individual encoders 220(0-N). The model output buffer 338 and individual encoders 220(0-N) are adjusted based on transmit information in order to maintain the delay (e.g., OBdelay_{N}) of the encoded bitstreams at a target level between a minimum delay level (e.g., minOBdelay_{N}) and maximum delay level (e.g., maxOBdelay_{N}). The model output buffer 338 delay OBdelay_{N} may be the level of the model output buffer 338 (e.g., OBdelay_{N}) divided by the target bitrate. In some embodiments, the model output buffer analysis may be performed for each encoded frame by comparing the release time of the first encoded coding unit to the decode time stamp (DTS) of the corresponding encoded frame and comparing the release time of the last encoded unit to the DTS of the corresponding encoded frame. The release time of an encoded unit is the time when the encoded unit is released from the encoder. The DTS indicates when the frame is to be removed from the buffer. In some embodiments, the maximum model output buffer delay for a given frame N may be calculated by comparing the difference between the decode time stamp of that frame (e.g., DTS_{N}) and the release time of the first encoded bit of frame N (e.g., T1_{N}). The maximum delay of the model output buffer for a given frame N may then be given by maxOBdelay_{N}=DTS_{N}−T1_{N}. In some embodiments, the minimum model output buffer delay for a given frame N may be calculated by comparing the difference between the decode time stamp of that frame (e.g., DTS_{N}) and the release time of the last encoded bit of frame N (e.g., T2_{N}). The minimum delay of the model output buffer for a given frame N may then be given by minOBdelay_{N}=DTS_{N}−T2_{N}.

The channel information may be provided to the MCU 334 in the raw multiplexer control signal, e.g. RAW MUX CTRL. The MCU 334 may adjust the bitrate of one or more encoded bitstreams 0-N provided in the MPTS at the output of the multiplexer 250 by providing channel information including adjusted bandwidth allocation and stuffing instructions to the multiplexer 250 via the multiplexer control signal, e.g. ALT MUX CTRL. The MCU 334 may then provide model output buffer feedback to the RC and model output buffer based on the channel information contained in the multiplexer control signal, e.g. ALT MUX CTRL. This channel information may include an indication of model output buffer underflow or an indication of model output buffer overflow and subsequent stuffing instructions. The MCU 334 may also provide multiplexer 250 bandwidth allocation instructions in the multiplexer control signal, e.g. ALT MUX CTRL, based on a smart bandwidth algorithm.

In some embodiments, if the MCU observes that minOBdelay_{N} is approaching zero, the MCU may indicate in the model output buffer feedback to the RC to increase the QP to the corresponding encoder in order to reduce the encoding rate of that corresponding channel. In this way, model output buffer underflow may be minimized. Alternatively, the RC may raise the corresponding channel's priority, so that the RAW MUX CTRL signal to the MCU will indicate that the corresponding channel should be drained faster by multiplexer 250.

In some embodiments, if the MCU observes that maxOBdelay_{N} is approaching the maximum model output buffer delay, the MCU may indicate in the model output buffer feedback to the RC to decrease the QP of that corresponding encoder in order to increase the encoding rate of that corresponding channel. This increase in encoder output may avoid buffer overflow by providing enough data for multiplexer 250 to maintain the CBR of the final MPTS bitstream. If buffer overflow does occur at a channel buffer, then the MCU can account for the missing data by stuffing the remaining space in the channel bitstream, for example with null packets. These stuffing instructions may be included in the multiplexer control signal, e.g. ALT MUX CTRL, that is sent to multiplexer 250 so that the encoded bitstreams in the final MPTS have a constant bitrate. Any stuffing generated by the MCU during multiplexing modeling may be reported back to the RC via the MCU feedback signal. The RC may then adjust the corresponding encoder to increase its encoding rate in order to better coordinate with the number of bits consumed by the multiplexer.

According some embodiments, the MCU may implement a smart bandwidth sharing algorithm in order to effectively allocate bandwidth for multiplexing among channels CH0-N according to the respective levels of pending encoded data, and to ensure that data is not stored too long in the buffers. In one example, the smart bandwidth algorithm may allocate bandwidth per channel within the bitrate pool based on the proportion of data that channel has stored in the buffer. A channel storing more data in the buffer will be allocated more bandwidth than another channel that stores proportionally less data in the buffer. The smart bandwidth sharing algorithm may also recognize that certain individual channels may be designated as premium channels by the RC. A premium channel would be allocated as much bandwidth as the channel requires for transmitting its data (subject to the channel's bitrate limit). The premium channel designation may minimize the chance that MCU feedback would reduce the quality of the premium channel bitstream.

The above example operation is provided for illustrative purposes, and is not intended to limit the disclosure. As explained above, while the description of operation of the statmux with multiple channel rate control 310 is based on encoding of frames, it will be appreciated that operation of the statmux system 300 may be based on buffering and encoding of coding units, such as macroblocks, and/or other sub-coding units, such as portions of a frame, and the encoded coding units or encoded sub-coding units are provided to the multiplexer 250 via the respective encoded bitstreams 0-N. It will be appreciated that, while FIG. 3 depicts three encoders, a statmux with multiple channel rate control 310 may include 2, or more than three encoders. The encoders 0-N 220 (0-N) may have different architecture and/or may encode the encoded frames of the respective CH0-N channels using different encoding methodologies or standards, and may operate at different rates. In some embodiments, the elements of the RC with multiple channel rate control 330 may operate at a rate least as great as a frame (e.g., or coding unit) rate of a channel of the CH0-N channels having a highest frame (e.g., or coding unit) rate.

Further, it will be appreciated that the logical connections between elements of the statmux with multiple channel rate control 310 may vary from the connections depicted in FIG. 3. For example, the actual encoded frame size may be provided directly to the model output buffer 338, rather than being provided via the rate controller 336. It will be appreciated that encoding of channels may include other dependencies beyond bitrates and timing.

FIG. 4B is a schematic block diagram of an encoding system 451 according to an embodiment of the disclosure. The encoding system 451 may include an encoder 452, which may be implemented using encoders 220(0-N) of FIGS. 2 and 3, and may operate in accordance with one or more encoding standards in the art, known now or in the future. The encoder 452 may be implemented in semiconductor technology, and may be implemented in hardware, software, or combinations thereof.

The encoder 452 may include an encoding path having, a mode decision block 453, a delay buffer 454, a transform 455, a quantizer 456, and an entropy encoder 463. In some embodiments, a plurality of QP values may be provided by the quantizer 456. The mode decision block 453 may select a coding mode based on a QP value, including a QP value supplied by the rate controller with multiple rate control 230 and/or the plurality of QP values provided by the quantizer. Available coding modes may be applied on a per frame, slice, and/or macroblock basis. The coding modes may include, but are not limited to, intra-modes, inter-modes and/or skip/direct modes. Each of these modes may further involve a selection of a set of motion vectors (out of plurality of motion vectors provided by the motion estimation block).

The output of the mode decision block 453 may be utilized by a prediction module 462 to generate a predictor in accordance with H.264 normative methods, MPEG-2 normative methods, or other prediction techniques. The predictor may be subtracted from a delayed version of the video signal at the subtractor 464. Using the delayed version of the video signal may provide time for the mode decision block 453 to act. The output of the subtractor 464 may be a residual, e.g. the difference between a macroblock and its prediction.

The transform 455 may be configured to perform a transform, such as a discrete cosine transform (DCT), on the residual to produce a set of blocks of coefficients (typically by processing the residual in blocks of 8×8 pixels or 4×4 pixels) that may, for instance, correspond to spectral components of data in the video signal. Generally, the transform 455 may transform the residual to a frequency domain representation of the residual referred to as a set of coefficient blocks.

The quantization block 456 may be configured to receive the coefficient block and quantize the coefficients of the coefficient block to produce a quantized coefficient block based on a selected QP value. The quantization provided by the quantization block 456 may be lossy. The QP value may be adjusted for each macroblock or for any other unit, and may be based on information encoded by the encoder 452.

The entropy encoder 463 may encode the quantized coefficient block with an encoding technique, such as CAVLC. The entropy encoder 463 may receive syntax elements (e.g., quantized coefficients, differential motion vectors, macroblock modes, etc.) from other devices of the macroblock encoder 452, such as the quantizer 456 and/or prediction module 462. The entropy encoder 463 may be any entropy encoder known by those having ordinary skill in the art or hereafter developed, such as a variable length coding (VLC) encoder or a binary arithmetic coding encoder (e.g. CABAC).

In some embodiments, the encoder 452 may operate in accordance with the MPEG-2 video coding standard and the H.264 video coding standard. Thus, because the MPEG-2 and the H.264 video coding standards employ motion prediction and/or compensation, the encoder 452 may further include a feedback path that includes an inverse quantizer 457, an inverse transform 458, a reconstruction adder 459, and a deblocking filter 460. These elements may mirror elements included in a decoder (not shown) that is configured to reverse, at least in part, the encoding process performed by the encoder 452. Additionally, the feedback loop of the encoder may include a decoded picture buffer 461 and the prediction block 462.

The quantized coefficient block may be inverse quantized by the inverse quantizer (Q⁻¹) 457 to provide recovered coefficients, and the recovered coefficients for a macroblock may be inverse transformed by the inverse transform (T⁻¹) 458 to produce a reconstructed macroblock residual. The reconstructed residual may be added to the predictor at the reconstruction adder 459 and after combining with the remaining reconstructed macroblocks produce reconstructed video frame, which may be deblocked by the deblocking filter 460, written to the decoded picture buffer 461 for use for prediction in encoding subsequent frames, and fed back to the macroblock prediction module 462 and to the mode decision block 453 for further in-macroblock intra prediction or other mode decision methodologies. In some examples, the deblocking filter may be removed or bypassed, and the reconstructed video frame may be provided directly to the decoded picture buffer 461 from the reconstruction adder 459.

In an example operation of the encoder 452, a video signal (e.g., a base band video signal) may be provided to the encoder 452. The video signal may be provided to the delay buffer 454, the RD and the mode decision block 453. The mode decision block 453 may select a coding mode, which is provided to the prediction module 462. The prediction module 462 may provide a motion prediction. The subtractor 464 may receive the video signal from the delay buffer 454 and may subtract the motion prediction from the video signal to generate a residual. The residual may be provided to the transform 455 and processed using a forward transform, such as a DCT. The transform 455 may generate a coefficient block that may be provided to the quantizer 456, and the quantizer 456 may quantize the coefficient block. Quantized coefficients and other syntax elements may be provided to the entropy encoder 463 and encoded into an encoded bitstream.

The block of quantized coefficients may be inverse quantized, inverse transformed, and added to the motion prediction signal by the inverse quantization block 457, the inverse transform 458, and the reconstruction adder 459, respectively, to produce a reconstructed video signal. Both the prediction block 462 and the deblocking filter 460 may receive the reconstructed video signal, and the decoded picture buffer 461 may receive a filtered video signal from the deblocking filter 460 or the reconstructed video signal directly from the reconstruction adder 459. Based on the reconstructed and filtered video signals, the prediction block 462 may provide a motion prediction signal to the adder.

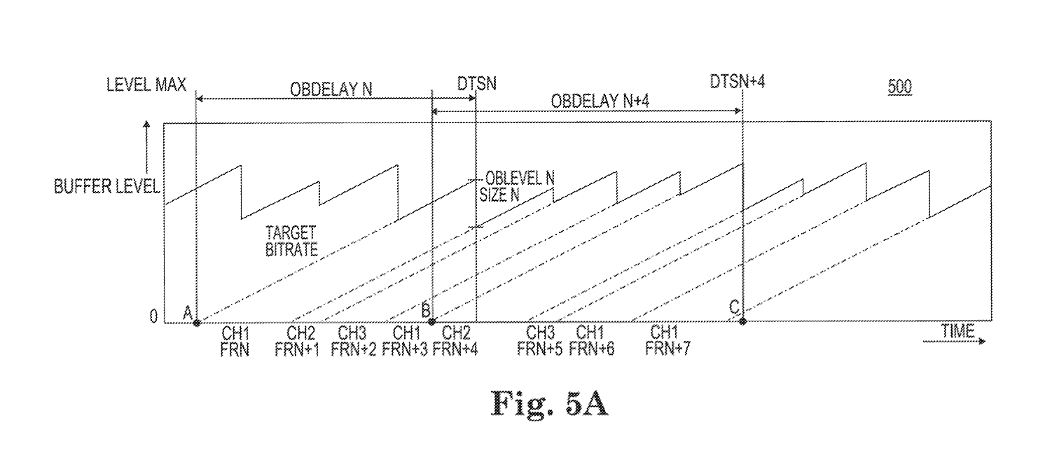

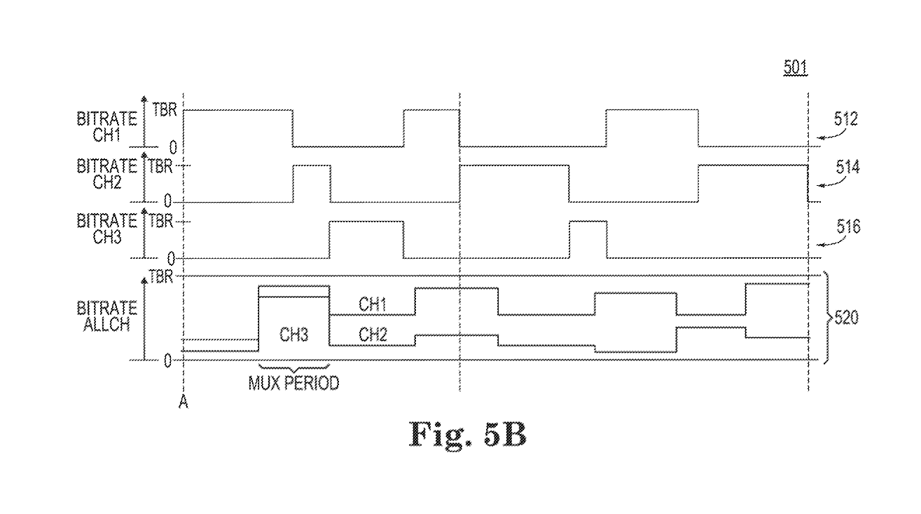

FIGS. 5A and 5B are exemplary timing diagrams of a model output buffer and multiple channel rate control as described with reference to FIGS. 1-4. In the exemplary timing diagram 500, the horizontal axis represents time and the vertical axis represents a level of the model output buffer (e.g. an amount of data in the model buffer). The exemplary timing diagram 500 is depicted from a perspective of a decoder. Thus, rather than depicting new frames filling the model output buffer, new frames are instantaneously pulled/removed from the model output buffer (e.g., to be decoded). Further, rather than the model output buffer being drained the target constant bitrate, the model output buffer is filled at the target constant bitrate. An example of a selection of a group of encoded frames may include encoded frames FRN-FRN+7. The selection of the group of encoded frames based on the model output buffer depicted in the exemplary timing diagram 500 may be performed by the statmux with multiple channel rate control 110 of FIG. 1, the statmux with the multiple channel rate control 210 of FIG. 2, and/or the statmux with multiple channel rate control 310 of FIG. 3.

In the exemplary timing diagram 500, an exemplary buffer level is depicted being filled over time at the target bitrate with encoded frames FRN-FRN+7 being removed. The selection of the group of encoded frames may start with an initial encoded frame. In this example, the initial encoded frame is encoded frame FRN. The DTS_{N} identifies the time at which the encoded frame FRN will be removed from the model output buffer. As explained with reference to FIG. 4, based on the buffer level corresponding to frame N (e.g., OBlevel_{N}), the OBdelay_{N} can be determined (e.g., OBlevel_{N}/the target bitrate).

FIG. 5B depicts an exemplary timing diagram 501 depicting exemplary transmission bitrates associated with channels CH1-3 in transmitting of the encoded frames FRN-FRN+7 from FIG. 5A with and without multiple channel rate control. During transmission without multiple channel rate control, the high values of CH1 512, CH2 514, and CH3 516 represent the target bitrate TBR and the low values represent zero. Thus, between time A and time B, the encoded frames FRN-FRN+3 are sequentially transmitted, with a bitrate of the corresponding channel CH1-3 equal to the target bitrate TBR during transmission of a corresponding frame and a bitrate of zero when not transmitting an encoded frame. Similarly, between time B and time C, the encoded frames FRN+4-FRN+7 are transmitted.

During transmission with multiple channel rate control, the high value of the communication link 520 represents the target bitrate TBR and the low values represent zero. As depicted, between time A and time B, each channel CH1-3 has a respective bitrate that is based on the relative sizes of the encoded frames FRN-FRN+3. Also, since two frames corresponding to channel CH1 are transmitted between time A and time B (e.g., FRN and FRN+3), the transmission of the encoded frame FRN is completely transmitted before the encoded frame FRN+3 begins being transmitted. The bitrate associated with each channel CH1 512, CH2 514, and CH3 516 remains constant between time A and time B, rather than fluctuating between the target bitrate and zero, as in the example without multiple channel rate control. As the timing diagram 520 shows, the bitrate associated with each channel CH1 512, CH2 514, and CH3 516 is time-shifted for each multiplexing period (MUX PERIOD) so that the final MPTS can be maintained at a constant bitrate (CBR) over each multiplexing period. This time-shifting is the result of the multiplexer control signal, e.g. ALT MUX CTRL, instructions that are provided by the MCU to multiplexer 250. The multiplexer control signal, e.g. ALT MUX CTRL, may include instructions that may inform the multiplexer when to drain bits from individual channel buffers so that CBR of the final multiplexed MPTS can be maintained.

It will be appreciated that, while the exemplary timing diagrams 500 and 501 depict three channels to be multiplexed together between time A and time B and between time B and time C, the selected channels may be more or less three channels. Further the relative frame sizes may be any combinations of sizes. Further, while the timing diagram 501 depicts respective bitrates associated with channels CH1-3, the respective bitrates may vary from the respective bitrates depicted based on relative sizes of encoded frames associated with each channel CH1-3. It will also be appreciated that, while exemplary timing diagrams depicts selecting encoded frames from three channels, encoded frames from any number of channels CH0-CHN may be selected. Further, the target bitrate may be any bitrate, such as a constant bitrate of an associated communication link.

Components described herein, including but not limited to the statmux systems, rate controllers, and encoders described herein, may be implemented in all or in part using software in some examples. The software may be implemented using instructions encoded on one or more computer readable media. Any electronic storage (e.g. memory) may be used to implement the computer readable media, which may be transitory or non-transitory. The computer readable media may be encoded with instructions for performing the acts described herein, including but not limited to, rate control, encoding, QP selection, buffering, and combinations thereof. The instructions may be executable by one or more processing units to perform the acts described. The processing units may be implemented using any number and type of hardware capable of executing the instructions including, but not limited to, one or more processors, circuitry, or combinations thereof.

The method 600 may be implemented by a field-programmable gate array (FPGA) device, an application-specific integrated circuit (ASIC), a processing unit such as a central processing unit (CPU), a digital signal processor (DSP), a controller, another hardware device, a firmware device, or any combination thereof. As an example, the method 500 may be implemented by a computing system using, for example, one or more processing units that may execute instructions for performing the method that may be encoded on a computer readable medium. The processing units may be implemented using, e.g. processors or other circuitry capable of processing (e.g. one or more controllers or other circuitry). The computer readable medium may be transitory or non-transitory and may be implemented, for example, using any suitable electronic memory, including but not limited to, system memory, flash memory, solid state drives, hard disk drives, etc. One or more processing units and computer readable mediums encoding executable instructions may be used to implement all or portions of encoders or encoding systems described herein.

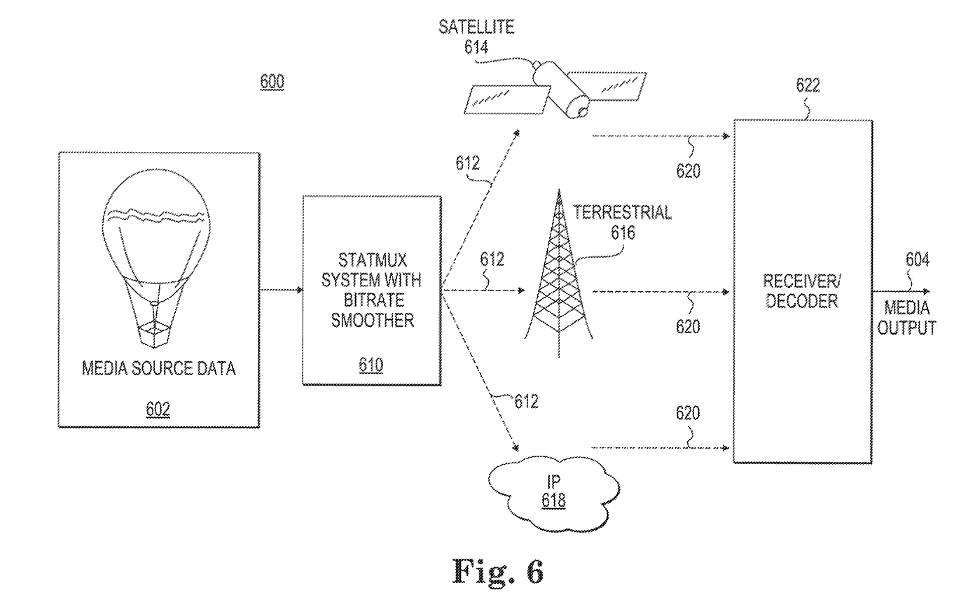

FIG. 6 is a schematic illustration of a media delivery system 600 in accordance with embodiments. The media delivery system 600 may provide a mechanism for delivering a media source 602 to one or more of a variety of media output(s) 604. Although only one media source 602 and media output 604 are illustrated in FIG. 6, it is to be understood that any number may be used, and examples may be used to broadcast and/or otherwise deliver media content to any number of media outputs.

The media source data 602 may be any source of media content, including but not limited to, video, audio, data, or combinations thereof. The media source data 602 may be, for example, audio and/or video data that may be captured using a camera, microphone, and/or other capturing devices, or may be generated or provided by a processing device. Media source data 602 may be analog or digital. When the media source data 602 is analog data, the media source data 602 may be converted to digital data using, for example, an analog-to-digital converter (ADC). The media source data 602 may represent several channels of media source data. Typically, to transmit each channel of the media source data 602, some type of compression and/or encryption may be desirable, with the compressed/encrypted channels being distributed over a common link. Accordingly, a statistical multiplexer with multiple channel rate control 610 may be provided that may encode each channel of the media source data 602 using any encoding method in the art, known now or in the future, including encoding methods in accordance with video standards such as, but not limited to, MPEG-2, MPEG-4, H.264, HEVC, or combinations of these or other encoding standards.

The statistical multiplexer with multiple channel rate control 610 may combine encoded data of each channel, or selected channels, of the media source data 602 based on a bandwidth of a communication link and to provide the combined encoded data 612 over a communications link. In other examples, channels may be received from multiple source data instances. Examples of communications links may include a satellite 614, an antenna 616, and/or a network 618. The statistical multiplexer with multiple channel rate control 610 may be implemented using any statistical multiplexer with multiple channel rate control described herein, including the statistical multiplexer with multiple channel rate control 110 of FIG. 1, the statistical multiplexer with multiple channel rate control 210 of FIG. 2, and/or the statistical multiplexer with multiple channel rate control 310 of FIG. 3. The network 618 may be wired or wireless, and further may communicate using electrical and/or optical transmission. The antenna 616 may be a terrestrial antenna, and may, for example, receive and transmit conventional AM and FM signals, satellite signals, or other signals known in the art. The communications communication link may broadcast the combined encoded data 612, and in some examples may alter the combined encoded data 612 and broadcast the altered combined encoded data 612 (e.g., by re-encoding, adding to, or subtracting from the combined encoded data 602). The combined encoded data 620 provided from the communications communication link may be received by a receiver 622 that may include or be coupled to a decoder. The decoder may decode the combined encoded data 620 to provide one or more media outputs, with the media output 604 shown in FIG. 6.

The receiver 622 may be included in or in communication with any number of devices, including but not limited to a modem, router, server, set-top box, laptop, desktop, computer, tablet, mobile phone, etc.

The media delivery system 600 of FIG. 6 and/or the statistical multiplexer with multiple channel rate control 610 may be utilized in a variety of segments of a content distribution industry.

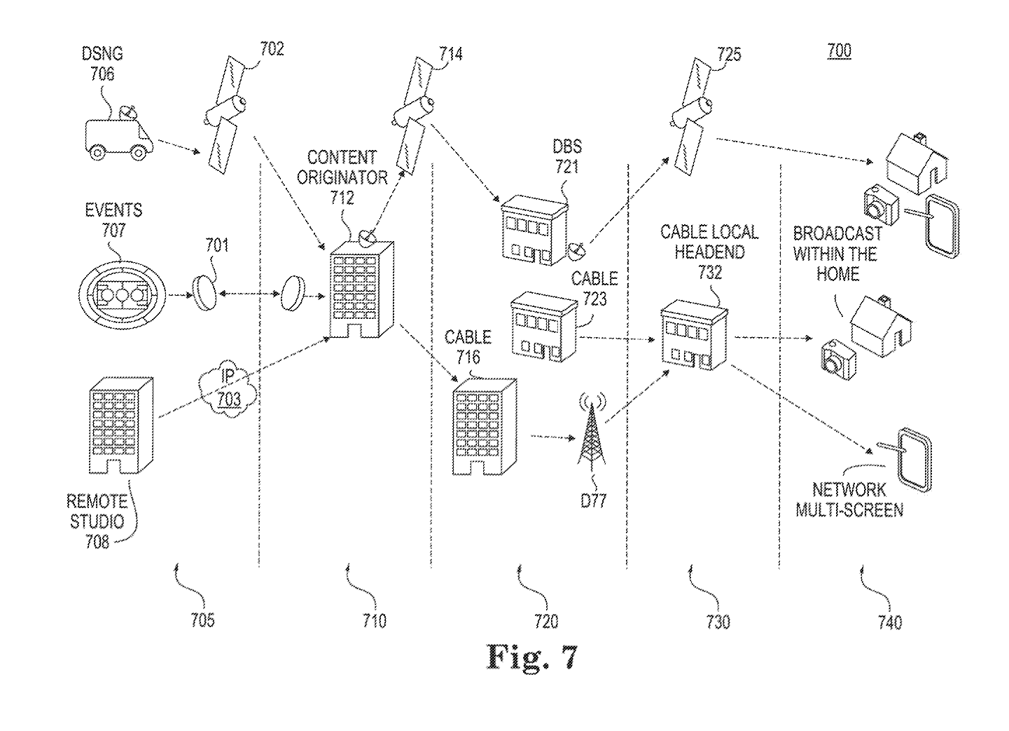

FIG. 7 is a schematic illustration of a video distribution system that 700 may make use of encoders described herein. The video distribution system 700 includes video contributors 705. The video contributors 705 may include, but are not limited to, digital satellite news gathering systems 706, event broadcasts 707, and remote studios 708. Each or any of these video contributors 705 may utilize statistical multiplexers with a bitrate smoother described herein, such as the statistical multiplexer with multiple channel rate control 610 of FIG. 6, to encode and combine multiple channels of media source data and provide combined channel encoded data to a communications link. The digital satellite news gathering system 706 may provide combined channel encoded data to a satellite 702. The event broadcast 707 may provide combined channel encoded data to an antenna 701. The remote studio 708 may provide combined channel encoded data over a network 703.

A production segment 710 may include a content originator 712. The content originator 712 may receive combined channel encoded data from any or combinations of the video contributors 705. The content originator 712 may make the received content available, and may edit, combine, and/or manipulate any of the received content to make the content available. The content originator 712 may utilize statistical multiplexers with global RC described herein, such as the statistical multiplexer with multiple channel rate control 610 of FIG. 6, to provide combined channel encoded data to the satellite 714 (or another communications link). The content originator 712 may provide combined channel encoded data to a digital terrestrial television system 716 over a network or other communication link. In some examples, the content originator 712 may utilize a decoder to decode the content received from the contributor(s) 705. The content originator 712 may then re-encode and combine data; potentially utilizing statistical multiplexers with global RC described herein, such as the statistical multiplexer with multiple channel rate control 610 of FIG. 6, and provide the combined channel encoded data to the satellite 714. In other examples, the content originator 712 may not decode the received data, and may utilize a transcoder (which may include an encoder of the statistical multiplexer with the bitrate smoother 610 of FIG. 6) to change an encoding format of the received data.

A primary distribution segment 720 may include a digital broadcast system 721, the digital terrestrial television system 716, and/or a cable system 723. The digital broadcasting system 721 may include a receiver, such as the receiver 622 described with reference to FIG. 6, to receive combined channel encoded data from the satellite 714. The digital terrestrial television system 716 may include a receiver, such as the receiver 622 described with reference to FIG. 6, to receive combined channel encoded data from the content originator 712. The cable system 723 may host its own content which may or may not have been received from the production segment 710 and/or the contributor segment 705. For example, the cable system 723 may provide its own media source data 602 as that which was described with reference to FIG. 6.

The digital broadcast system 721 may include an encoder, such as the statistical multiplexer with multiple channel rate control 610 of FIG. 6, to provide encoded data to the satellite 725. The cable system 723 may include a statistical multiplexer with VBV shifter, such as the statistical multiplexer with multiple channel rate control 610 of FIG. 6 as described with reference to FIG. 6, to provide combined channel encoded data over a network or other communications communication link to a cable local headend 732. A secondary distribution segment 730 may include, for example, the satellite 725 and/or the cable local headend 732.

The cable local headend 732 may include a statistical multiplexer with bitrate smoother, such as the statistical multiplexer with multiple channel rate control 610 of FIG. 6, to provide combined channel encoded data to clients in a client segment 740 over a network or other communications link. The satellite 725 may broadcast signals to clients in the client segment 740. The client segment 740 may include any number of devices that may include receivers, such as the receiver 622 and associated decoder described with reference to FIG. 6, for decoding content, and ultimately, making content available to users. The client segment 740 may include devices such as set-top boxes, tablets, computers, servers, laptops, desktops, cell phones, etc.

Accordingly, encoding, transcoding, and/or decoding may be utilized at any of a number of points in a video distribution system. Embodiments may find use within any, or in some examples all, of these segments.

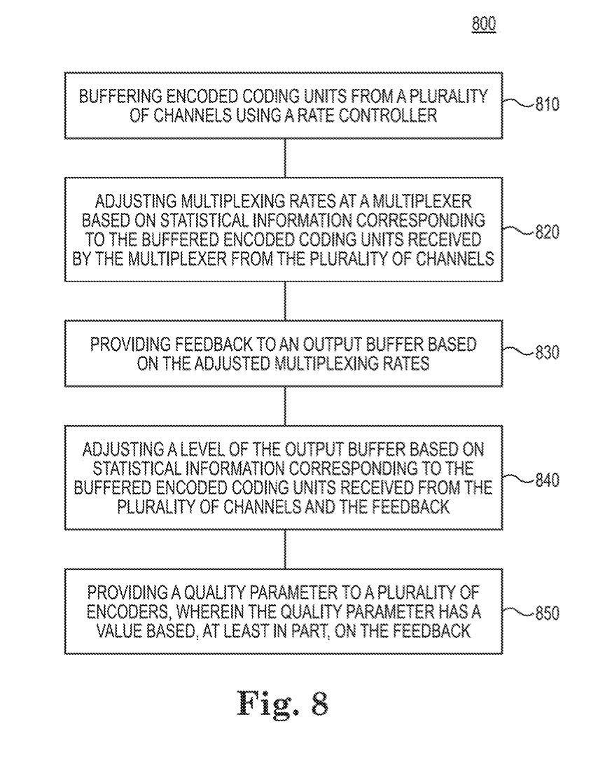

FIG. 8 is a flowchart 800 for a method for implementing multiple channel rate control of individual channels according to an embodiment of the disclosure. The method illustrated by the flowchart 800 may be implemented by the statmux with multiple channel rate control 110 of FIG. 1, the statmux with multiple channel rate control 210 of FIG. 2, and/or the statmux with multiple channel rate control 310 of FIG. 3.

The method 800 may include buffering encoded coding units from a plurality of channels using a rate controller, at 810. Each of the plurality of encoded coding units may correspond to a respective channel. The encoded coding units may be buffered by the statmux with multiple channel rate control 110 of FIG. 1, the rate controller with multiple channel rate control 230 of FIG. 2, and/or rate controller 336 of FIG. 3. In an embodiment, statistical information may be provided by a rate controller, such as the rate controller 336 of FIG. 3.

The method 800 may further include adjusting multiplexing rates at a multiplexer based on statistical information corresponding to the buffered encoding received by the multiplexer from the plurality of channels, at 820. The method 800 may further include providing feedback to an output buffer based on the adjusted multiplexing rates at 830. Method 800 may further include adjusting a level of the output buffer based on statistical information corresponding to the buffered encoded coding units received from the plurality of channels and the feedback at 840. The multiplexing instructions may be adjusted by the statmux with multiple channel rate control 230 of FIG. 2, and/or the multiplexer control unit 334 of FIG. 3. The feedback may also be generated by the multiplexer control unit 334 of FIG. 3. In an embodiment the multiplexing may be performed by a multiplexer, such as multiplexer 350 of FIG. 3. The output buffer may correspond to the model output buffer 338 of FIG. 3. The statistical information corresponding to the buffered encoded coding units may include information regarding encoded frames, such as but not limited to, information indicating an actual size of an encoded frame, unquantized frame size, complexity information based on a quality parameter, premium channel designation, or combinations thereof.

Method 800 may further include providing a quality parameter to the plurality of encoders, wherein the quality parameter has a value based, at least in part, on the feedback, at 850. The value of the quality provided to each of the encoders may be based on statistical information from more than one channel, including other channels not directly associated with an individual encoder. The encoders may encode coding units of an associated channel based on the provided quality parameter and provide the encoded coding units in a respective encoded bitstream. The feedback may include any stuffing instructions that were generated by the multiplex control unit, such as multiplex control unit 334 of FIG. 3.

From the foregoing it will be appreciated that, although specific embodiments of the disclosure have been described herein for purposes of illustration, various modifications may be made without deviating from the spirit and scope of the disclosure. Accordingly, the disclosure is not limited except as by the appended claims.

What is claimed is:

1. An apparatus, comprising:
a statistical multiplexing (statmux) system for use with a communication link, the statmux system comprising:
a rate controller;
a multiplex control unit; and
a plurality of encoders, wherein an encoder of the plurality of encoders is configured to receive a respective channel of a plurality of channels, the rate controller configured to buffer respective coding units received on at least two of the plurality of channels, the rate controller further configured to provide channel information regarding the plurality of channels and multiplexing instructions to the multiplex control unit, the multiplex control unit configured to alter the multiplexing instructions and provide feedback to the rate controller, the rate controller configured to provide a quality parameter to the plurality of encoders, wherein the quality parameter has a value based on the feedback from the multiplex control unit.

2. The apparatus of claim 1, wherein the multiplex control unit is configured to adjust the multiplexing instructions to change an allocation of bitrate bandwidth between the at least two of the plurality of channels.

3. The apparatus of claim 2, wherein the multiplex control unit is configured to alter the multiplexing instructions to provide stream stuffing to a bitstream of at least one of the plurality channels.

4. The apparatus of claim 3, wherein the stream stuffing comprises stuffing the at least one of the plurality of channels with null packets.

5. The apparatus of claim 1, wherein the channel information includes premium channel designation.

6. The apparatus of claim 1, further comprising a model output buffer, wherein a level of the model output buffer is updated in a first direction based on sizes of encoded coding units received from the plurality of encoders and is updated in a second direction based on a target bitrate.

7. The apparatus of claim 6, wherein the rate controller is further configured to update the level of the model output buffer based on the feedback from the multiplex control unit.

8. The apparatus of claim 1, further comprising a multiplexer, wherein the multiplexer is configured to receive the altered multiplexing instructions from the multiplex control unit.

9. The apparatus of claim 8, wherein the multiplexer is configured to time-multiplex the encoded bitstreams from the plurality of encoders based on the altered multiplexing instructions from the multiplex control unit.

10. The apparatus of claim 9, wherein the multiplexer is configured to provide a multiplexed output of encoded coding units that has a constant bitrate.

11. The apparatus of claim 10, wherein the constant bitrate is equal to a constant bitrate of the communication link.

12. A non-transitory computer-readable medium encoded with instructions comprising instructions that, when executed by one or more processing units, cause the one or more processing units to:
adjust multiplexing rates at a multiplexer based on statistical information corresponding to buffered coding units received by the multiplexer from the plurality of channels;
provide feedback to an output buffer based on the adjusted multiplexing rates;
adjust a level of the output buffer based on the statistical information corresponding to the buffered coding units received from the plurality of channels and the feedback; and
provide respective quality parameters to a plurality of encoders, wherein the quality parameters have values based, at least in part, on the feedback.

13. The non-transitory computer readable medium of claim 12, wherein the instructions further comprise instructions that when executed by one or more processing units cause the one or more processing units to:
provide a first quality parameter having a first value to a first encoder of the plurality of encoders; and
provide a second quality parameter having a second value to a second encoder of the plurality of encoders.

14. The non-transitory computer-readable medium of claim 13, wherein the instructions further comprise instructions that, when executed by the one or more processing units, cause the one or more processing units to adjust multiplexing rates for the plurality of channels based on the levels of buffered coding units received from the plurality of channels, wherein a first channel of the plurality of channels is multiplexed at a first rate relative to a first level of buffered coding bits, and a second channel is multiplexed at a second rate relative to a second level of buffered coding bits.

15. The non-transitory computer-readable medium of claim 14, wherein the instructions further comprise instructions that, when executed by the one or more processing units, cause the one or more processing units to receive statistical information from each of the plurality of encoders based on a respective encoding unit, wherein the adjusted multiplexing rates are based on respective statistical information of an associated channel of the plurality of channels.

16. The non-transitory computer-readable of claim 14, wherein a buffered coding unit comprises a buffered frame of a channel of the plurality of channels.

17. A method, comprising:
buffering encoded coding units from a plurality of channels using a rate controller;
adjusting multiplexing rates at a multiplexer based on statistical information corresponding to the buffered encoded coding units received by the multiplexer from the plurality of channels;
providing feedback to an output buffer based on the adjusted multiplexing rates;
adjusting a level of the output buffer based on statistical information corresponding to the buffered encoded coding units received from the plurality of channels and the feedback; and
providing respective quality parameters to a plurality of encoders, wherein the quality parameters have values based, at least in part, on the feedback.

18. The method of claim 17, wherein adjusting multiplexing rates comprises adjusting the multiplexing bitrate bandwidth allocated to each channel based on the proportion of buffered coding units received from each channel to the total buffered coding units.

19. The method of claim 17, wherein adjusting multiplexing rates comprises allocating a maximum allowable multiplexing bitrate bandwidth to each channel having statistical information containing a premium channel designation.

20. The method of claim 17, wherein adjusting multiplexing rates comprises stuffing at least one channel of the plurality of channels with null packets.
